(19) United States
(12) Patent Application Publication
(10) Pub. No.: US 2008/0085338 A1
(43) Pub. Date: Apr. 10, 2008

(54) Pet Food

(76) Inventor: Stephanie J.M. Krammer, Lorrach-Hauingen (DE)

Correspondence Address: NIXON & VANDERHYE, PC, 901 NORTH GLEBE ROAD, 11TH FLOOR, ARLINGTON, VA, 22203, US

(21) Appl. No.: 11/794,118

(22) PCT Filed: Dec. 19, 2005
(86) PCT No.: PCT/EP05/13641

§ 371 Date: Jun. 25, 2007

(51) Int. Cl. A23K 1/18; A23K 1/00; A23K 1/16

(52) U.S. Cl. 426/2; 426/546

(57) ABSTRACT

The present invention relates to pet food. More particularly the present invention provides a pet food comprising Epigallocatechingallate (EGCG) in a concentration of from 0.001% to 3% by weight, for example from 0.01% to 3% by weight, preferably from 0.1% to 2% by weight. EGCG is a polyphenol derived from the green tea plant Camellia sinensis. It may be added to the cat food in any form, including, e.g., green tea extracts containing varying amounts of EGCG as well as highly enriched EGCG preparations such as the EGCG preparation obtained by the process as described in EP 1,077,211. In this process EGCG is highly enriched starting from any green tea extract, e.g. green tea leaves are typically extracted with hot or cold water to form a solution containing tea catechins and caffeine. This green tea solution can be further concentrated to form either a concentrated extract solution or a dry powder. Tea extract powders are commercially available e.g. from Guizhou Highyin Biological Product Co., Guiyang, P. R. China, or Zhejang Zhongke Plant Technical Co. Ltd., Hangzhou, Zhejang, P. R. China. Suitably, EGCG is present in the compositions of the present invention in a concentration of from about 0.001 to about 3% (w/w). By adding the green tea extract, i.e. EGCG as an additive to pet food, bacteria in the oral cavities of pets can be reduced and inflammatory diseases can be suppressed since the green tea extract, i.e. EGCG has an antibacterial effect.

The present invention relates to pet food more particularly to that capable of preventing periodontal diseases of dogs and cats.

Pet food is processed from fish, meat, milk and the like with additional dairy products, vegetables, vitamins and so on. There are many types of pet food such as dry-type food in which less than 10% of water is contained, semi-moist-type food in which 20-40% of water is contained and wet-type food in which more than 70% of liquid, i.e. water or milk is contained. These types of pet food, especially wet-type cat food containing more than 70% water or milk, are packed in containers by about 100 g.

In addition, there recently has provided pet food having a deodorant effect so that feces and urine of cats and dogs may not make a foul smell. Such pet food often contains a very small quantity (from 0.01 to 0.02% by weight) of a green tea extract as an additive, which has an antibacterial effect. The feed of green tee extracts to cats and dogs has a big disadvantage. Since the green tea extract has a bitter and stringent taste because of tannin, its principal ingredient, it is hard for cats and dogs to take it. Therefore in order to let the pets take the extract spontaneously every day only a few manufacturers add a very small quantity of that to pet food.

When pets are continuously fed with pet food made especially for them, dental plaque is significantly accumulated in their mouths and oral bacteria causing gingivitis and periodontitis can be detected. As a result, bad breath develops in cats.

Such diseases of cats are of a great interest for their owners. Thus, there has been a long-felt need for preventing such diseases.

The present invention provides pet food comprising Epigallocatechingallate (EGCG) as a green tea extract in a concentration of from 0.001% to 3% by weight, for example from 0.01% to 3% by weight, preferably from 0.1% to 2% by weight. EGCG is a polyphenol derived from the green tea plant Camellia sinensis. It may be added to the cat food in any form, including, e.g., green tea extracts containing varying amounts of EGCG as well as highly enriched EGCG preparations such as the EGCG preparation obtained by the process as described in EP 1,077,211. In this process EGCG is highly enriched starting from any green tea extract, e.g. green tea leaves are typically extracted with hot or cold water to form a solution containing tea catechins and caffeine . This green tea solution can be further concentrated to form either a concentrated extract solution or a dry powder. Tea extract powders are commercially available e. g. from Guizhou Highyin Biological Product Co., Guiyang, P. R. China, or Zhejang Zhongke Plant Technical Co. Ltd., Hangzhou, Zhejang, P. R. China. Suitably, EGCG is present in the compositions of the present invention in a concentration of from about 0.001 to about 3% (w/w).

By adding the green tea extract, i.e. EGCG as an additive to pet food, bacteria in the oral cavities of pets can be reduced and inflammatory diseases can be suppressed since the green tea extract, i.e. EGCG has an antibacterial effect.

Furthermore, the present invention provides dry- and wet-type pet food containing EGCG in a concentration of from 0.001% to 3% by weight, for example from 0.01% to 3% by weight, preferably from 0.1% to 2% by weight.

In another preferred aspect the present invention provides wet-type cat food containing from 0.001% to 3% by weight of a green tea extract. Cat milk a preferred wet-type cat food preferably contains EGCG in an amount from about 0.1 mg/kg diet to about 300 mg/kg diet.

In yet another aspect, the present invention relates to the use of EGCG in the manufacture of a pet food for preventing or treating plaque, gingivitis, periodontal disease and oral malodor (halitosis) in cats and dogs, and for enhancing the antioxidative capacity in the whole organism; and for the use of the aforesaid ingredient for preventing or treating plaque, gingivitis, periodontal disease and oral malodor (halitosis) in cats and dogs, and for enhancing the antioxidative capacity in the whole organism. In order to guarantee an efficient effect the pet food contains EGCG in an amount sufficient to administer to a subject a daily dosage of 0.1 mg per kg body weight to about 100 mg, preferably 20 mg per kg body weight.

In yet another aspect, the present invention relates to the use of EGCG in the manufacture of a pet food for weight reduction in cats and dogs. In order to guarantee an efficient effect the pet food contains EGCG in an amount sufficient to administer to a subject a daily dosage of 0.1 mg per kg body weight to about 100 mg, preferably 20 mg per kg body weight.

The pet food according to the present invention contains for example EGCG in a concentration of about 30 mg/kg by weight to about 1000 mg/kg by weight, based on the total weight of the pet food and may be based on any conventional pet food. There is a wide range of pet foods available, which may be grouped into
(a) complete diets,
(b) complementary diets, and
(c) snacks and treats.

Complete diets may be fed in addition to water for an extended period as the sole source of nutrients and will provide for all the energetic and nutrient needs of the animal and the physiological state for which it is intended. Complementary diets normally are not sufficient to ensure that all nutrient and energy requirements are met unless fed in combination with another foodstuff or diet. Snacks and treats are appetizers or for occasional feeding and are considered as complementary products.

The pet food of the present invention may be in a dry, canned, semi-moist or baked form. Typical components of such compositions, in addition to the inventive ingredient, are crude protein, crude fat, carbohydrates, starch, crude fibers, and ash, further on minerals, trace elements, vitamins, fatty acids, protein and amino acids, choline, carnitin, dietary fiber and substances required for balanced diets of the different animal species. Basic ingredients of such food compositions are:
Crude Protein including proteins and N-containing compounds of non-proteinaceous nature, e.g. acid amides, amines, free amino acids, ammonium salts, alkaloids;
Crude Fat including neutral fats, lipoids (phospho-, sphingo lipids, steroids) and other ethersoluble compounds;
N-free Extractions (NFE) including polysaccharides (starch, glycogen), soluble saccharides (glucose, fructose, saccharose, lactose, maltose and oligosaccharides), and soluble fractions of cellulose, hemicellulose, lignin and pectines;
Crude Fibers including insoluble fractions of cellulose, hemicellulose, lignin and other components of the cell wall like suberin, cutin etc.;
Ash including minerals (macrominerals such as calcium, phosphorus, sodium, chloride, potassium, magnesium, and microminerals, i.e., trace elements, such as iron, copper manganese, zinc, iodine, selenium,) and further inorganic substances e.g. silicate.
Vitamins including vitamins A, B1, B2, B6, B12, D, pantothenic acid, niacin, biotin, folic acid, linolic acid and choline.

Further components may, e.g. be omega-6-fatty acids, omega-3-fatty acids, L-carnitine, chondroitin sulfate, glucosamine, glutamine/glutamic acid, arginine, taurine and hydroxyproline.

Typical components which provide the ingredients for a dog food composition, in addition to EGCG, comprise e.g., chicken/beef/turkey, liver, broken pearl barley, ground corn, brute fat, whole dried egg, fowl protein hydrolyzate, vegetable oil, calcium carbonate, choline chloride, potassium chloride, iodinized salt, iron oxide, zinc oxide, copper sulfate, manganese oxide, sodium selenite, calcium iodate, provitamin D, vitamin B₁, niacin, calcium panthothenate, pyridoxin hydrochloride, riboflavin, folic acid, biotin, vitamin B₁₂.

Typical components which provide the ingredients for a cat food composition, in addition to EGCG, comprise beef, chicken meat, dried chicken liver, lamb meat, lamb liver, pork, turkey meat, turkey liver, poultry meal, fish meal, fowl protein hydrolysate, animal fats, plant oils, soy bean meal, pea bran, maize gluten, whole dry egg, ground corn, corn flour, rice, rice flour, dry sugar beet molasses, fructooligosaccharides, soluble fibres, plant gums, cellulose powder, clay, bakers yeast, iodized sodium chloride, calcium sulfate, sodium triphosphate, dicalcium phosphate, calcium carbonate, potassium chloride, choline chloride, magnesium oxide, zinc oxide, iron oxide, copper sulfate, iron sulfate, manganese oxide, calcium jodate, sodium selenite, provitamin D, thiamine, niacin, calcium pantothenate, pyridoxine hydrochloride, riboflavin, folic acid, biotin, vitamin B12, taurin, L-carnitine, caseine, D-methionine.

Wet pet food contains about 70% and more moisture.

A typical wet food for adult dogs may, e.g. comprise, in addition to EGCG, at minimum 24% protein, 15% fat, 52% starch, 0.8% fibre, 3% linolic acid, 0.6% calcium, 0.5% phosphorus, the Ca:P ratio being 1:1, 0.2% potassium, 0.6% sodium, 0.09% chloride, 0.09% magnesium, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B₁, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B₁₂, 2500 mg/kg of choline, 0.8 mg/kg biotin, 2500 mg/kg cholin, all percentages being based on dry weight of the total food composition.

A typical wet food for adult cats may, e.g. comprise, in addition to EGCG, at minimum 44% protein, 25% fat, 20% starch, 2.5% fibre, 0.8% calcium, 0.6% phosphorus, 0.8% potassium, 0.3% sodium, 0.09% chloride, 0.08% magnesium, 0.25% taurin, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, 0.8 mg/kg biotin, 2500 mg/kg cholin, all percentages being based on dry weight of the total food composition.

Dry pet food contains between about 6 and about 14% moisture and about 86% and more dry matter.

A typical dry food for adult dogs may, e.g. comprise, in addition to EGCG, at minimum 25% protein, 12% fat, 41.5% starch, 2.5% fibre, 1% linolic acid, 1% calcium, 0.8% phosphorus, the Ca:P ratio being 1:1, 0.6% potassium, 0.35% sodium, 0.09% chloride, 0.1% magnesium, 170 mg/kg of iron, 35 mg/kg of copper, 70 mg/kg of manganese, 220 mg/kg of zinc, 4 mg/kg of iodine, 0.43 mg/kg of selenium, 15000 IU/kg of vitamin A, 1200 IU/kg of vitamin D, 11 mg/kg of vitamin B₁, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B₁₂, 2500 mg/kg of choline, 0.8 mg/kg biotin, all percentages being based on dry weight of the total food composition.

A typical dry food for adult cats may, e.g. comprise, in addition to EGCG, at minimum 32% protein, 15% fat, 27.5% starch, 11% dietetic fibres, 4.5% fibre, 3.4% linolic acid, 0.08% arachidonic acid, 0.15% taurin, 50 mg/kg L-camitin, omega 6/3=5, 1% calcium, 0.8% phosphorus, the Ca:P ratio being at least 1:1, 0.6% potassium, 0.4% sodium, 0.6% chloride, 0.08% magnesium, 190 mg/kg of iron, 30 mg/kg of copper, 60 mg/kg of manganese, 205 mg/kg of zinc, 2.5 mg/kg of iodine, 0.2 mg/kg of selenium, 25000 IU/kg of vitamin A, 1500 IU/kg of vitamin D, 20 mg/kg of vitamin B1, 40 mg/kg of riboflavin, 56 mg/kg of pantothenic acid, 153 mg/kg of niacin, 14 mg/kg of pyridoxine, 3.2 mg/kg of folic acid, 0.2 mg/kg of vitamin B12, 1 mg/kg of biotin, 3000 mg/kg of choline, all percentages being based on dry weight of the total food composition.

A preferred cat food composition of the present invention is in the form of a wet-type milk product.

A typical wet-type milk food for cats may, e.g. comprise, in addition to EGCG, at minimum 3% raw protein, 2% raw fat, 0.5% to 0.3% ashes, at minimum 80% moisture, 0.8% raw starch, vitamins A, E, B1, B2, B6 and/or B12 in a range of from 0.001 mg to about 5 mg per kg food, wherein all percentages being based on dry weight of the total food composition.

Dry food may be prepared, e.g., by screw extrusion including cooking, shaping and cutting of raw ingredients into a specific kibble shape and size in a very short period of time, while simultaneously destroying detrimental micro-organisms. The ingredients may be mixed into homogenous expandable dough and cooked in an extruder (steam/pressure) and forced through a plate under pressure and high heat. After cooking, the kibbles are then allowed to cool, before optionally being sprayed with a coating which may include liquid fat or digest including liquid or powdered hydrolyzed forms of an animal tissue such as liver or intestine from, e.g., chicken or rabbit. Hot air drying then reduces the total moisture content to 10% or less.

Canned (wet) food may be prepared, e.g., by blending the raw ingredients including meats and vegetables, fatty acids, gelling agents, gravies, vitamins, minerals and water. The mix is then fed into cans on a production line, the lids are sealed on and the filled cans are sterilized at a temperature of about 130° C. for about 50 to 100 min.

The pet foods of the present invention are useful in preventing or treating plaque, gingivitis, periodontal disease and oral malodor (halitosis) in dogs and cats, and for enhancing the antioxidative capacity in the whole organism.

Plaque is a soft, gelatinous material composed of bacteria and their metabolic byproducts, oral debris, and salivary components. Mature plaque is not removed by normal actions of the tongue or by rising of the mouth. Rather, mechanical abrasion from chewing or tooth brushing is necessary for plaque removal.

Left undisturbed, aerobic and facultative anaerobic bacteria proliferate as the plaque thickens and matures. Over time, salivary calcium salts are deposited on the plaque, producing calculus. Calculus is a hard deposit that provides a rough surface, promoting accumulation of more plaque and also contributing to tissue damage as it extends into the gingival sulcus. Gingivitis occurs when plaque and calculus form at the neck of the tooth, leading to inflammation and tissue damage. As the gingival sulcus enlarges into a periodontal pocket, the area provides an oxygen-depleted environment that allows proliferation of anaerobic bacteria. Periodontal disease becomes established when the periodontal ligament is exposed to plaque, bacteria, and bacterial byproducts.

In some animals gingivitis persists without progressing into periodontitis. However, in most, untreated gingivitis eventually progresses to periodontal disease. Clinical signs of gingivitis and periodontal disease include oral malodor, gingival sensitivity and bleeding, tooth loss, and difficulty in eating.

Oral malodor (halitosis) is commonly reported in cats and is perceived by many owners to be a significant problem. Being associated with gingivitis and periodontitis one explanation for halitosis may be that chronic inflammation and tissue damage provides increased protein substrate for microorganisms in the mouth, enhancing the production of VSCs, volatile sulfur compounds. These compounds, particularly mercaptyl sulfide and hydrogen sulfide, produce breath malodor when exhaled.

The presence and proliferation of certain species of anaerobic bacteria and the inflammatory responses of the host contribute to the progressive destruction of the periodontium. As the supporting connective tissues and adjacent bone are weakened, teeth become loose and may be lost. Periodontal disease itself causes discomfort and pain and, if left untreated, can lead to bacteremia.

Odontoclastic resorptive lesions in cats also have been associated with gingival inflammation and, possibly, periodontal disease.

Since the majority of periodontal pathogens are gram-negative bacteria which release endotoxins (lipopolysaccharides—LPS) dental diseases are a potential risk factor for systemic disease in cats resulting in a systemic bacteremia or LPS challenge.

The importance of maintaining healthy periodontal tissues is of greater significance when considered that chronic periodontal disease my have a systemic as well as local effects. The most important factor that influences the development of gingivitis and periodontal disease in the dog and cat is the presence and persistence of undisturbed plaque on tooth surface. Once plaque has been deposited on the surface of the tooth, it may be reduced mechanically through abrasion provided by diet, chewing on supplemental chew toys or foods. The use of antimicrobial agents like chlorhexidine digluconate in conjunction with brushing, and the use of a chemical mouthwash is not effective in removing the hardened calculus that forms when plaque is allowed to accumulate.

Antioxidative capacity in the whole organism is a means to reflect the organism's capability to withstand oxidative stress and protect cell membrane and cytosolic components against free radical damage. The higher the antioxidative capacity the higher its ability to neutralize free radicals and arrest the chain effect of free radical damage thereby playing a vital role in maintaining the health and integrity of individual cells.

The amount of plaque forming bacteria may be determined by counting the bacteria commonly considered responsible for the pathogenesis of periodontitis, e.g. Streptococcus mutans, Eikenella corrodens and Porphyromonas gingivalis, and further Prevotella ssp, Bacteroides gingivalis, Bacteroides intermedius, Actinobacillus and Actinobacillus. For example, subgingival plaque may be taken from the maxillary premolars of dogs with a scalar. Saliva, tongue dorsum and bucal mucosa may be obtained as cotton swabs. Each specimen may be placed immediately, e.g., in sterile oxygen free tubes containing, e.g. 10 ml GAM broth and stored in an anaerobic glove box with 70% N2, 15% CO2, and 15% H2. The diluted suspension of each sample may, e.g., be placed on Brain Heart Infusion agar with 7% horse blood for total counts, and Brucella HK agar with 7% horse blood for counts of genus Porphyromonas as black-pigmented bacteria. Identification and bacterial count of representative colonies may be carried out using Rapid ANA II system, AIP 20A and API-ZYM systems. For Streptococcus mutans a Brain Heart Infusion would be used, too. The conditions used would be aerobic. After incubation at 37° C. for 48 hours, MICs would be estimated using the systems mentioned above.

Gingivitis (oral inflammation) may be determined by measuring the gingival index, a method for estimating severity of inflammation of the gums.

To determine changes in, especially, white blood cells, a total blood count may be carried out.
Red blood cell count: Hemoglobin, hematocrit, number of erythrocytes, erythrocyte indices MCHC, MCH, MCV.
White blood cell count: Total number of leukocytes, differential blood count (Basophiles, neutrophiles, eosinophiles, monocytes, thrombocytes, B- and T-lymphocytes) relative and absolute.

Parameters for the determination of the antioxidant capacity include TEAC (Trolox equivalent antioxidant capacity) which may be measured, e.g. after a 1:1 dilution with a spctrophotometer, on which absorbance values were recorded over 3 minutes, according to the method of Armstrong and Browne, Adv Exp Med Biol 366:43-58 (1994), Total Antioxidant Capacity (TAC), Erythrocyte Superoxid Dismutase (SOD) which may, e.g., be determined based on the method developed by McCord and Fridovich, J Biol Chem 244:6056-63 (1969) coupling O2-generators (xanthine and xanthine oxidase (XOD)) with an O2-detector [2-(4-iodophenyl)-3-(4-nitrophenol)-5-phenyltetrazolium chloride] and monitoring absorbance in a spectrophotometer; Ferritin which may be determined by an enzyme-linked immunoassay, Ceruloplasmin which may be determined by a calorimetric method to determine ceruloplasmin oxidase activity; Vitamin E and C; CK; GOT which may be determined by using a fluorescence detector at a wavelength of 334 nm.

The following examples illustrate the invention further.

### EXAMPLE 1

Commercial dry dog food (Hill's Science diet “Canine Maintenance dry”, as supplied by Hill's Pet Nutrition GmbH, Germany) is sprayed with an aqueous solution of EGCG (as supplied by DSM Nutritional Products Ltd.) in an amount sufficient to provide 0.001% to 3.0% by weight of EGCG in the final food composition. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain dry matter of about 90% by weight.

### EXAMPLE 2

Commercial wet dog food (Hill's Science diet “Canine Maintenance wet”, as supplied by Hill's Pet Nutrition GmbH, Germany) is mixed with an aqueous solution of EGCG (as supplied by DSM Nutritional Products Ltd.) in an amount sufficient to provide 0.001% to 3.0% by weight of EGCG in the final food composition. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### EXAMPLE 3

Commercial dog treats (Mera Dog “Biscuit” for dogs, as supplied by Mera Tiernahrung GmbH, Germany) are sprayed with an aqueous solution of EGCG (as supplied by DSM Nutritional Products Ltd.) in an amount sufficient to provide 0.001% to 3.0% by weight of EGCG in the final food composition. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### EXAMPLE 4

Commercial dry cat food (Hill's Science diet “Feline Maintenance dry”, as supplied by Hill's Pet Nutrition GmbH, Germany) is sprayed with an aqueous solution of EGCG (as supplied by DSM Nutritional Products Ltd.) in an amount sufficient to provide 0.001% to 3.0% by weight of EGCG in the final food composition. F Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### EXAMPLE 5

Commercial wet cat food (Hill's Science diet “Feline Maintenance wet”, as supplied by Hill's Pet Nutrition GmbH, Germany) is sprayed with an aqueous solution of EGCG (as supplied by DSM Nutritional Products Ltd.) in an amount sufficient to provide 0.001% to 3.0% by weight of EGCG in the final food composition. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### EXAMPLE 6

To a low-lactose milk-drink for cats containing sugars and minerals (Friskis Milk, as supplied by Friskis, Finnland) EGCG (as supplied by DSM Nutritional Products Ltd.) in aqueous solution and in an amount sufficient to provide 0.001% to 3.0% by weight of EGCG in the final food composition is added.

### EXAMPLE 7

To a lactose reduced, ambient cat milk enriched with vitamins A, E, B1, B2, B6, B12, iron and taurin, (Cat-Milk, as supplied by Vitakraft, Belgium) EGCG (as supplied by DSM Nutritional Products Ltd.) in aqueous solution and in an amount sufficient to provide 0.001% to 3.0% by weight of EGCG in the final food composition is added.

### EXAMPLE 8

To a cat milk containing milk dairy products and vegetable by-products (Catmilk, as supplied by Whiskas Masterfoods, Germany) EGCG (as supplied by DSM Nutritional Products Ltd.) in aqueous solution and in an amount sufficient to provide 0.001% to 3.0% by weight of EGCG in the final food composition is added.

Use of Epigallocatechingallate in the Prevention of Periodontal Disease in Cats

Periodontopathic conditions are the most common disease in dogs and cats. Especially in cats, prophylaxis is usually limited to professional dental cleaning under anaesthesia. Special diets which reduce plaque and calculus accumulation have been formulated to extend the period of time between professional dental cleanings. The study was conducted to determine the effect of EGCG in a regular dry diet on the oral health of cats. In addition, the in vitro antibacterial activity of the substance and its effect on the antioxidant status of cats were evaluated.

The substance under investigation was sprayed on a standard dry cat food. The supplemented diet contained 227 mg/kg of EGCG.

18 cats were made available for the feeding study, being assigned either to a control group or a study group, each group containing 9 cats. At the beginning of the trial, which was conducted over a period of 28 days, the oral health status of the cats was examined using various indices and tests, and samples from the oral cavity were obtained for bacteriological analysis. In addition, blood samples were taken to determine the antioxidant status of the animal.

The examinations were followed by a coronal cleaning (scaling and polishing) to ensure that the study period began with no plaque or calculus present on tooth surfaces (“clean tooth” model).

Over the following 28 days, the study group was given the prepared feed (epigallocatechingallate) and the control group was given the placebo feed.

At day 28 of the trial the cats were examined again, and all the evaluations carried out at the start of the trial were repeated.

Data collected on day 0 and day 28 were compared within and between the two groups, with a view to determining the effect of epigallocatechingallate on the parameters under investigation.

The in vitro investigations of the antibacterial activity of the substance showed promising results. Epigallocatechingallate proved able to inhibit the growth bacteria taken from the feline oral cavity in vitro. With a view to achieving better in vivo results, a change in the dosage, and possibly also a change in the mode of administration, can be considered. Further, the active ingredient can be administered in higher concentration, or in such a way as to prolong the time of its contact with the oral cavity. Epigallocatechingallate proved to have an effect on the antioxidant status of the cats. This was investigated as a secondary target variable. Some parameters of the antioxidant status showed tendencies to improvement, others evinced a significant improvement of the antioxidant status as compared with the control group. It can be safely assumed that epigallocatechingallate, in the dosage used in this trial, does have a positive effect on the antioxidant status of the cat. All this results came out without the use of additional active substances as for example lactoferrin, which—as already published—seems to have comparable effects.

1. A pet food containing Epigallocatechingallate (EGCG) as a green tea extract in a concentration of from 0.001% to 3% by weight.

2. Pet food according to claim 1 comprising Epigallocatechingallate in a concentration of from 0.01% to 3% by weight, preferably from 0.1% to 2% by weight.

3. Pet food as in claim 2 containing EGCG in an amount sufficient to administer to a subject a daily dosage of 0.1 mg per kg body weight to about 100 mg, preferably 20 mg per kg body weight.

4. Pet food as in claim 2, wherein the concentration of EGCG is about 30 mg/kg by weight to about 1000 mg/kg by weight, based on the total weight of the pet food.

5. Wet-type cat food according to claim 1 containing EGCG in an amount from about 0.1 mg/kg diet to about 300 mg/kg diet.

6. Wet-type cat food according to claim 5 wherein it is a milk-product.

7. Use of Epigallocatechingallate (EGCG) in a concentration of from 0.001% to 3% by weight, for example from 0.01% to 3% by weight, preferably from 0.1% to 2% by weight in the manufacture of a food, particularly for dogs or cats, for preventing or treating plaque, gingivitis, periodontal disease and oral malodor (halitosis) in cats, and for enhancing the antioxidative capacity in the whole organism.

8. Use of a pet food of claim 1 in preventing or treating plaque, gingivitis, periodontal disease and oral malodor in cats, and for enhancing the antioxidative capacity in the whole cat organism.

9. The use as in claim 7, wherein from about 0.1 mg/kg body weight to about 100 mg, preferably 20 mg/kg body weight per day of EGCG is administered to the pet.
